(19) United States
(12) Patent Application Publication
(10) Pub. No.: US 2010/0271315 A1
(43) Pub. Date: Oct. 28, 2010

(54) ENCODING AND DECODING ADAPTIVE INPUT DEVICE INPUTS

(75) Inventor: Steven Bathiche, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/431,686

(22) Filed: Apr. 28, 2009

(51) Int. Cl. G06F 3/041; G06F 3/02

(52) U.S. Cl. 345/173; 345/168

(57) ABSTRACT

Systems and methods for encoding and decoding adaptive device inputs are provided. The system may include a computing device coupled to an adaptive input device having a mechanical key set including a plurality of mechanically depressible keys, each key including a touch display. The computing device may comprise code stored in mass storage for implementing via a processor, a touch display application program interface configured to receive encoded input device data including one or more of mechanical key-down input data and touch input data, decode the encoded input device data to identify one or more of a key command corresponding to the mechanical key-down input data and a touch command corresponding to touch input data from one or more keys, and send one or more messages to an adaptive input device application based on the identified key command and/or touch commands.

### BACKGROUND

In recent years touch screens have been incorporated into a multitude of computing devices available in a wide array of consumer markets. Touch screens provide flexibility as compared to fixed layout keyboards; however, their smooth, flat surfaces do not provide rich haptic feedback to users, such as the tactile feeling of key depression or scroll wheel revolution. Haptic feedback may be helpful to enable quick and accurate interaction with an input device, with less reliance on visual observation of the input device. One challenge associated with incorporating mechanical input mechanisms such as depressible keys and scroll wheels into touch sensitive devices to provide haptic feedback, is that processing and interpreting input data from an input device with both mechanical input mechanisms and a touch screen may necessitate the use of multiple device drivers and input processing modules on the computing device, leading to inefficient data processing and overused computer resources.

### SUMMARY

Systems and methods for encoding and decoding adaptive device inputs are provided. The system may include a computing device coupled to an adaptive input device having a mechanical key set including a plurality of mechanically depressible keys, each key including a touch display. The computing device may comprise code stored in mass storage for implementing via a processor, a touch display application program interface configured to receive encoded input device data including one or more of mechanical key-down input data and touch input data, decode the encoded input device data to identify one or more of a key command corresponding to the mechanical key-down input data and a touch command corresponding to touch input data from one or more keys, and send one or more messages to an adaptive input device application based on the identified key command and/or touch commands.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective view of an embodiment system for encoding and decoding adaptive device inputs, including an adaptive input device and an associated computing device.

FIG. 2 is a schematic view of the adaptive input device and the associated computing device shown in FIG. 1.

FIG. 3 is a schematic view depicting an exemplary procedure which may be used to encode user input detected via the adaptive input device shown in FIG. 2.

FIG. 4 illustrates a flowchart of one embodiment of a method for decoding inputs from an adaptive input device.

### DETAILED DESCRIPTION

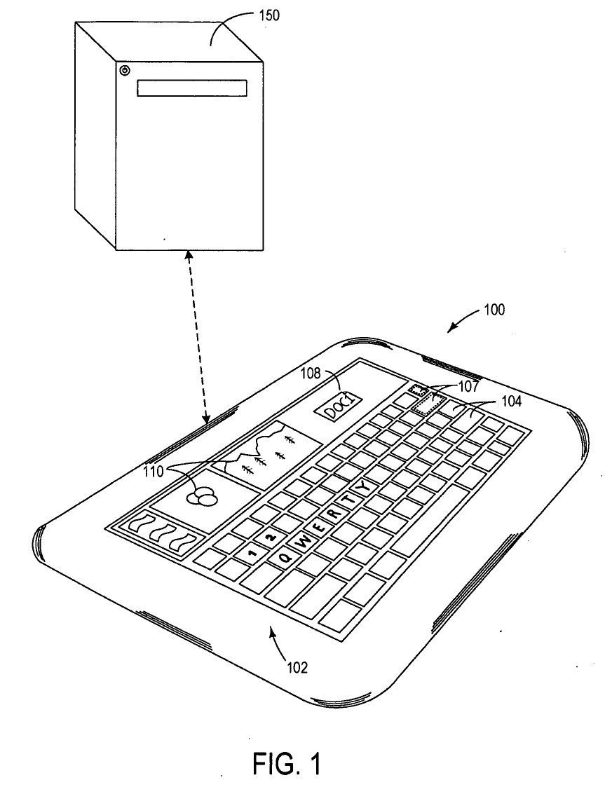

FIG. 1 illustrates a computing device 150 coupled to an adaptive input device 100 having a mechanical key set 102 including a plurality mechanically depressible keys 104, which may be spatially fragmented such that gaps are formed between the keys 104. The keys may be configured to receive a mechanical key-down input, by depression of a mechanical key in a downward direction via a digit (e.g. finger) of a user or other suitable actuation apparatus, such as a stylus.

One or more of the keys 104 may include a touch display 107 formed on the key, and thus the entire adaptive input device 100 may include a plurality of touch displays 107. Although a desktop computing device is depicted, it will be appreciated that the adaptive input device 100 may be coupled to other suitable computing devices including, but not limited to, a laptop computer, kiosk, a server bank, a portable electronic device, media player, mobile telephone, etc.

In the illustrated embodiment the mechanical key set 102 is arranged in a QWERTY key configuration. However, it will be appreciated that the key indicia and corresponding key commands may be adjusted based on the operating state of the computing device 150. In particular, the indicia displayed on one or more keys may be modified via the touch displays 107, the modification being in response to a command received from an application program in use on the computing device. For example, in a gaming application program a mechanical key-down input of a key with the indicia “W” may fire a weapon within the gaming interface. Therefore, the key formerly displaying an indicia “W” may be adjusted to display a weapons icon. Likewise, a key command corresponding to the mechanical key-down input from a key may be modified to correspond to the operating state of the computing device 150 and/or the adaptive input device 100. In this way the adaptive input device may be adjusted based on the operating state of the computing device.

Additionally in this embodiment, at least one ancillary display 108, which may be touch sensitive, may be included in the adaptive input device 100. The ancillary display 108 may be spaced apart from the mechanical key set 102. Various graphical elements 110 (e.g. icons, pictures, videos, etc.) may be presented on the ancillary display depending on the operating state of the adaptive input device 100 and/or computing device 150. However, it will be appreciated that in other embodiments, the ancillary display 108 may not be included in the adaptive input device 100 or may be included in a separate input device (not shown).

The plurality of touch displays 107 and the ancillary displays 108 may form display regions of a logically contiguous composite display that is pixel addressable across the entire adaptive input device 100. Thus, graphical output from computing device 150 may be sent for display on the composite display of the adaptive input device 100, across the touch displays 107 and ancillary displays 108.

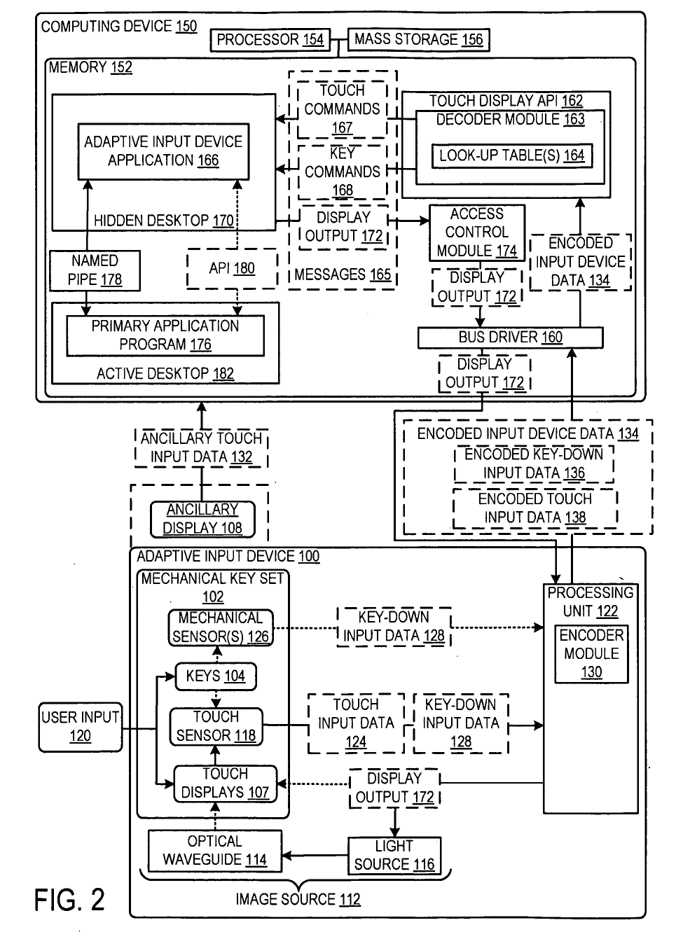

FIG. 2 illustrates a schematic depiction of the adaptive input device 100 and the computing device 150. As discussed above, the adaptive input device 100 may include a mechanical key set 102. The mechanical key set may include a plurality of keys 104. Additionally, each key may include a touch display 107, and thus the mechanical key set in its entirety may include a plurality of touch displays 107. However, it will be appreciated that in some examples, only a portion of the keys may include a touch display. As illustrated in this embodiment, the touch displays 107 are coupled to a suitable image source 112, such as an optical waveguide 114, which may be formed in a wedge or other suitable shape, and coupled to a light source 116. The image source 112 may be configured to provide the touch displays 107 with graphical content. Suitable light sources may include a laser, lamp, light emitting diode (LED), etc. However, it will be appreciated that in other embodiments other suitable images sources may be utilized. The images sources may include but are not limited to liquid crystal displays (LCDs), cathode ray tubes (CRTs), organic light emitting diode (OLED) displays, or a combination thereof.

Continuing with the embodiment depicted in FIG. 2, the optical waveguide 114 may direct light to the touch displays 107. In particular, the optical waveguide 114 may be configured, via internal reflection, to direct light down the waveguide until it reaches a critical angle at which point the light exits the optical waveguide. In some examples images for display may be generate via adjustment of the light source 116. However, in other examples, a liquid crystal display (LCD) may be positioned above or coupled to the optical waveguide 114. Therefore, in the aforementioned example the optical waveguide may provide a backlight for the LCD which generates an image for display.

A touch sensor 118 may be coupled to keys 104 and/or the touch displays 107. Additionally or alternatively, the touch sensor 118 may be coupled to the optical waveguide 114. The touch sensor 118 may be configured to detect user input 120, such as a touch input and/or a mechanical key-down input. The touch input may be performed via a digit (e.g. finger) of a user or a stylus, for example. It will be appreciated that a touch input may include a touch gesture, which can be a single touch or a pattern of touch over time. It will also be appreciated that the touch input may be sensed by the touch sensor 118 concurrent with a mechanical key-down input, as the user presses the key downward, or independent of a mechanical key-down input, for example as the user gestures against a viewable surface of a touch display on a key, without depressing the key. These two types of touch input may be encoded so as to be distinguishable by downstream software components. Additionally, the touch sensor 118 may be coupled to a processing unit 122. Thus, touch input data 124 may be transferred from the touch sensor 118 to the processing unit 122.

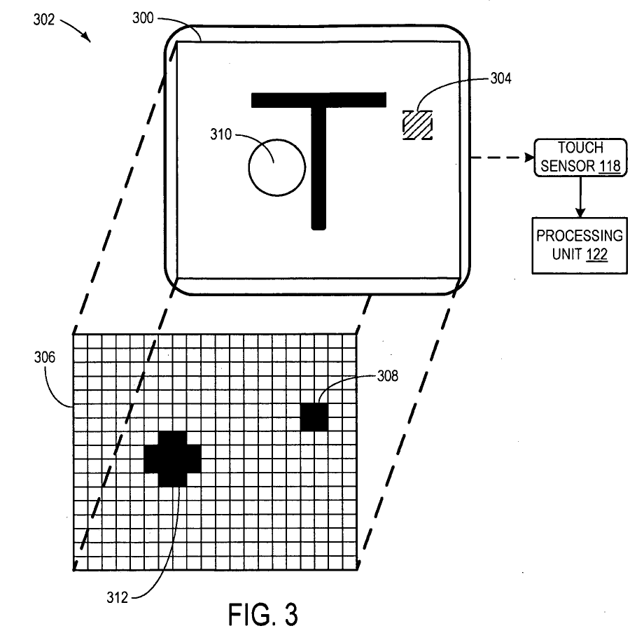

In some examples the touch sensor 118 may be one or more of an optical touch sensor configured to optically detect a touch input performed on a region of the adaptive input device and a capacitive touch sensor configured to detect an electrical change from a touch by a user. Exemplary optical sensors include an image sensor, such as a charge-couple device (CCD), a complementary metal-oxide-semiconductor (CMOS) sensor, etc. Additionally, in some examples, the optical touch sensor may be configured to detect movement of other objects proximate to the touch displays 107, such as the mechanically depressible keys 104. For example, one or more of the keys 104 may include a reflective portion, as illustrated in FIG. 3, discussed below. In turn, the optical touch sensor may be configured to detect movement of the reflective portion of the keys. Therefore, a key-down input may be detected by the optical touch sensor. In this way, the touch sensor may be configured to detect both a touch input as well as a mechanical key-down input.

However, it will be appreciated that one or more mechanical sensors 126 may be configured to detect a key-down input. The mechanical sensors 126 may be coupled to one or more keys, in some embodiments. Suitable mechanical sensors may include accelerometers and other motion and position sensors. Additionally, the mechanical sensors may be coupled to the processing unit 122, which may receive key-down input data 128 from the mechanical sensors 126. The processing unit 122 may be configured to, among other things, encode the key-down input data 128 via an encoder module 130. The touch input data 124 may also be encoded via the encoder module 130. The touch input data and/or the key-down input data may be encoded according to a predefined touch display schema. In some examples, encoding according to the touch display schema may include assigning spatial values corresponding to a pixel map for example, as shown in FIG. 3, to one or more of the key-down input data 128 and the touch input data 124. In this manner the relative location of the input data on the composite display of the adaptive input device 100 may be identified.

The touch input schema may be utilized by additional input devices such as the ancillary display 108. It will be appreciated that the ancillary touch display may be directly coupled to the computing device 150 and therefore may be configured to send ancillary touch input data 132 directly to the computing device. Alternatively, in other embodiments, the ancillary touch display may be coupled to the processing unit 122.

The processing unit 122 may send encoded input device data 134, including encoded key-down input data 136 and encoded touch input data 138, to the computing device 150.

Turning to computing device 150, the computing device may include various programs stored on mass storage 156 and executable via a processor 154 using portions of memory 152. In some embodiments, the mass storage 156 may be a hard drive, solid state memory, a rewritable disc, etc. The memory 152 may various programmatic elements described below. Specifically the memory may include a bus driver 160 configured to receive the encoded input device data 134 via a communications bus. In this embodiment, the bus driver 160 receives the encoded input device data 134 from the processing unit 122 of one adaptive input device, however it will be appreciated that a plurality of such devices may simultaneously be connected to the computing device 150. The bus driver 160 may be configured to provide support for various transport protocols, such as Universal Serial Bus (USB), Transport Control Protocol over Internet Protocol (TCP/IP), Bluetooth, etc., and send the messages over a communications bus using one or more of the aforementioned protocols. Thus, it will be appreciated that the adaptive input device may be wired or wirelessly connected to the computing device.

A touch display application program interface (API) 162 may be configured to receive the encoded input device data 134 which includes one or more of a mechanical key-down input data and touch input data. It will be appreciated that touch display API 162 is typically a private API, although in some embodiments it may be made public. Furthermore, the touch display API 162 may include a decoder module 163 configured to decode the encoded input device data 134. Decoding may include identifying one or more of a key command corresponding to the encoded touch input data from one or more keys. In some embodiments one or more look-up tables 164 may be used to decode the encoded input device data. Alternatively, another suitable technique may be used to decode the encoded input device data. In this way, both key commands as well as touch commands may be identified utilizing one API, rather than separate touch display and mechanical input APIs, thereby decreasing the amount of processing power needed to manage inputs from the adaptive input device, increasing the computing device's efficiency.

Furthermore, the touch display API 162 may be configured to send one or more messages 165 to an adaptive input device application 166. The messages may include touch commands 167 and/or key commands 168. In this embodiment, the adaptive input device application may be included in a hidden desktop 170. The term hidden desktop refers to a desktop that is not displayed (i.e., is hidden from display) on a monitor of the computing device, but instead is only displayed on an adaptive input device 100 of the computing device 150.

As discussed in detail below, the adaptive input device application 166 is configured to communicate with a primary application program 176 which belongs to the active desktop 182, and which typically has a graphical user interface visible on a monitor by the user. Input, such as touch commands 167 and key commands 168, received from the adaptive input device 100 may be passed to the application program 176, and a programmatic response may be generated by the application program 176 and sent back to the adaptive input device application 166. The adaptive input device application 166 may communicate with an application program 176 via an interprocess communication mechanism such as a named pipe 178. Additionally or alternatively, an API 180 may be used to communicate with the adaptive input device application 166.

Based on the response received from the application program, the adaptive input device application 166 may also be configured to generate and/or send a display output 172 to the bus driver 160 via an access control module 174. The display output 172 may include graphical elements (e.g. icons, alphanumeric symbols, pictures, etc.) mapped to one or more of the displays 107 and/or ancillary display 108. The specific mapping configuration of the graphical elements may depend upon the operating state of the computing device 150. The access control module 174 verifies that the requesting application program 176 has sufficient permissions to send output to the adaptive input device, and further resolves conflicts when multiple application programs attempt to send display output to the adaptive input device at concurrent or overlapping time intervals. Depending on the display technology employed, the display output 172 may be sent to the light source 116 for projecting through the optical waveguide 114 to the touch display, or alternatively may be sent directly to the touch display itself, as indicated.

FIG. 3 illustrates an exemplary encoding procedure which may be used to encode a touch input and/or a key-down input. A surface 300 of a key 302, which may be included in the mechanical key set 102, is illustrated. The key is marked with an indicia T, however it will be appreciated that the indicia may be adjusted depending on the operating state of the computing device, as previously discussed. The key may include a reflective portion 304. The touch sensor 118 may be configured to detect movement of the reflective portion 304 when the key 302 is depressed (e.g. key-down input). Thus a key-down input may be detected via the touch sensor. In this embodiment the processing unit 122 may be configured to spatially assign coordinate values and/or ranges of coordinate values to the reflective portion of the key on a touch display pixel map 306. Therefore, the key-down input data includes data corresponding to a key-down input region 308 on the touch display pixel map 306.

It will be appreciated that in alternate embodiments, the reflective portion 304 may not be included in the key 302, and that the processing unit 122 may spatially assign coordinate values and/or coordinate ranges to a key-down input data detected via a mechanical sensor. Thus, a key down switch may be used for each key, and the state of the switch may be encoded in a range of the pixel map 306 that is not used for receiving touch gestures.

Furthermore, a touch input 310 may be detected via the touch sensor 118. The processing unit 122 may be configured to spatially assign coordinate values and/or ranges of coordinate values to a touch input region. Therefore, touch input data includes data corresponding to the touch input region 312 on the touch display pixel map 306.

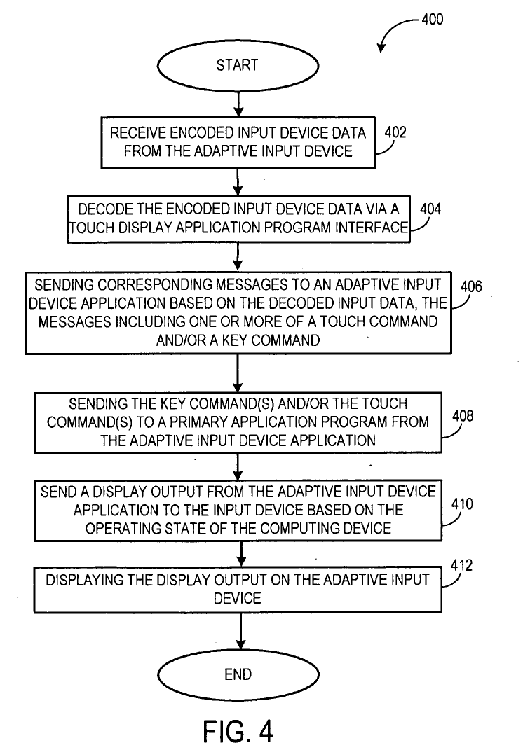

Turning now to FIG. 4, a method 400 is illustrated for operating a computing device. Method 400 may be implemented using the hardware and software components of the systems and devices described above. In particular, the method may be implemented via a computing device including a processor and mass storage. Furthermore, the computing device may be coupled to an adaptive input device including a mechanical key set having a plurality of mechanical depressible keys, each key including a touch display. However, in alternate embodiments the method 400 may be implemented using other suitable hardware and software components.

At 402, the method includes receiving encoded input data from the adaptive input device. In this embodiment the encoded input device input includes touch input data and mechanical key-down input data. Further in some embodiments, the encoded input data may be spatially encoded according to a pixel map. Still further in some embodiments the pixel map may be associated with two or more touch displays.

However in other embodiments, the encoded input data may be encoded via another suitable technique. The encoded input data may be received through a bus driver configured to receive the encoded input data via a transport protocol. Exemplary transport protocols include but are not limited to a USB, TCP/IP, and Bluetooth.

Next at 404 the method includes decoding the encoded input data via a touch display application program interface. In some embodiments decoding may include identifying the input device data corresponding to the touch commands and the input device corresponding to the key commands. The correspondence may be obtained from a look-up table or other suitable technique, for example.

As illustrated at 406, the method includes sending corresponding messages to an adaptive input device application based on the decoded input data, the messages including one or more of a touch command and a key command.

At 408, the method may further include in some embodiments, sending the key commands and/or the touch command to an application program from the adaptive input device application. In some embodiments the application program and the adaptive input device application are coupled via an interprocess communication mechanism, as described above.

Next at 410, the method 400 may further include in some embodiments sending a display output from the adaptive input device application to the input device based on the operating state of the computing device. In some exemplary embodiments the display output may be sent through an access control module configured to verify access rights of an application program to display on the adaptive input device. The aforementioned determination carried out via the access control module may be configured to verify access control privileges of an application program, and also to resolve conflicts between multiple competing programs that make concurrent or overlapping display requests. At 412, the method may include displaying the display output on the adaptive input device. The display output may be displayed, for example, on one or more touch displays associated with mechanically depressible keys, and/or on an ancillary display of the adaptive input device.

The above described systems and methods allow input data from an adaptive input device to be efficiently encoded and decoded, thereby enabling a touch display driver to receive both touch inputs and mechanical inputs. This may simplify development of drivers for adaptive input devices that employ both touch screens and mechanical input mechanisms, and decrease the amount of processing power devoted to the processing of inputs and outputs sent to and from the adaptive input device.

It will be appreciated that the embodiments described herein may be implemented, for example, via computer-executable instructions or code, such as programs, stored on a computer-readable storage medium and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to, a keyboard with computing functionality and other computer input devices.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A computing device coupled to an adaptive input device having a mechanical key set including a plurality of mechanically depressible keys, each key including a touch display, the computing device comprising code stored in mass storage for implementing via a processor:
a touch display application program interface configured to receive encoded input device data including one or more of mechanical key-down input data and touch input data, decode the encoded input device data to identify one or more of a key command corresponding to the mechanical key-down input data and a touch command corresponding to touch input data from one or more keys, and send one or more messages to an adaptive input device application based on the identified key command and/or touch commands.

2. The computing device of claim 1, wherein the touch display application program interface is configured to send a display output to the input device for display on the touch display.

3. The computing device of claim 1, wherein the adaptive input device application is coupled to an application program via an interprocess communication mechanism.

4. The computing device of claim 1, wherein touch display application program interface receives the encoded input device data from a bus driver configured to provide support for one or more transport protocols.

5. The computing device of claim 1, wherein the touch display application program interface decodes the input device input via a look-up table.

6. The computing device of claim 1, wherein the mechanical key-down input data includes data corresponding to a key-down input region on a touch display pixel map and touch input data includes data corresponding to a touch input region on the touch display pixel map.

7. The computing device of claim 6 wherein a range of coordinate values are assigned to a key-down input region on the touch display pixel map.

8. An adaptive input device for use with an associated computing device, the adaptive input device comprising:
a mechanical key set including a plurality of spatially fragmented mechanically depressible keys, each key including a touch display;
an image source configured to display graphical content on the touch displays;
a touch sensor coupled keys and/or the touch displays, the touch sensor configured to detect touch inputs on the keys and/or mechanical key-down inputs of the keys; and
an encoder module executed by a processing unit to receive input data including key-down input data corresponding to the mechanical key-down inputs and/or touch input data corresponding to the touch inputs and encode the input data according to a predefined touch input schema and send the encoded input device data to the associated computing device.

9. The adaptive input device of claim 8 wherein the image source is an optical waveguide coupled to a light source.

10. The adaptive input device of claim 8 wherein the touch sensor is one or more of an optical sensor and a capacitive touch sensor.

11. The adaptive input device of claim 8 further comprising one or more mechanical sensors coupled to one or more keys, the mechanical sensor configured to detect a mechanical key-down input.

12. A method for operating a computing device including a processor and mass storage, the computing device being coupled to an adaptive input device including a mechanical key set having a plurality of mechanically depressible keys, each key including a touch display, the method comprising:
receiving encoded input device data from the adaptive input device, the encoded input device data including touch input data and mechanical key-down input data;
decoding the encoded input device data via a touch display application program interface; and
sending corresponding messages to an adaptive input device application based on the decoded input data, the messages including one or more of a touch command and a key command.

13. The method according to claim 12, wherein decoding includes identifying the encoded input device data corresponding to the touch commands and the input device data corresponding to the key commands.

14. The method according to claim 12, further comprising sending the key commands and/or the touch commands to an application program from the adaptive input device application.

15. The method according to claim 14, wherein the primary application program and the adaptive input device application are coupled via an interprocess communication mechanism.

16. The method according to claim 12, further comprising sending a display output from the adaptive input device application to the input device based on an operating state of the computing device.

17. The method according to claim 16, wherein the display output is sent through an access control module configured to verify access rights of an application program to display on the adaptive input device.

18. The method according to claim 12, wherein the encoded input data is receive through a bus driver configured to receive the encoded input data via a transport protocol.

19. The method according to claim 12, wherein the encoded input data is spatially encoded according to a pixel map.

20. The method according to claim 19, wherein the pixel map is associated with two or more touch displays.
